(19) United States
(12) Patent Application Publication
(10) Pub. No.: US 2025/0268235 A1
(43) Pub. Date: Aug. 28, 2025

(54) BODY-WORN STRUCTURE

(71) Applicant: Che-Wen LIN, New Taipei City (TW)

(72) Inventor: Che-Wen LIN, New Taipei City (TW)

(21) Appl. No.: 19/196,772

(22) Filed: May 2, 2025

Related U.S. Application Data
(62) Division of application No. 17/823,884, filed on Aug. 31, 2022, now Pat. No. 12,317,864.

(51) Int. Cl. A01K 27/00

(52) U.S. Cl. CPC A01K 27/002; A01K 27/008

(57) ABSTRACT

A body-worn structure with combined multiple functions for outdoor activities. The body-worn structure comprises a flexible enclosure, an exit port and a wear-on port. Both the exit port and the wear-on port have an enlarged opening structure; the exit port includes a side extension port, a front opening or a shrinking piece; and the wear-on port includes a lower opening, a left opening, a right opening, or a rear opening. By the enlarged exit port and wear-on port, the distance between the exit port and the wear-on port can be decreased, so that the body-worn structure can be put on and taken off quickly.

### CROSS REFERENCE TO RELATED APPLICATIONS

This application is a Divisional of co-pending application Ser. No. 17/823,884, filed on 31 Aug. 2022.

### BACKGROUND OF THE INVENTION

### (a) Field of the Invention

The present invention relates to a body-worn structure, and more particularly to a structure that uses a support enclosure or a jacket body with combined multiple functions to facilitate the user in meeting the various different needs for outdoor activities.

### (b) Description of the Prior Art

The present invention of the body-worn structure is capable of covering a variety of target subjects. Moreover, apart from the covering body having waterproof and windproof functions, the application range of the body-worn structure further includes application in body protective devices for either protective clothing, hollow sphere, hollow airbag, or airbag clothing.

For a bike, scooter or motorcycle rider, a conventional raincoat or windbreaker is usually folded and then put into a storage compartment of the vehicles. When there is unexpected heavy rain in a rainy season, the rider must stop the vehicle and have it parked by a road side before opening the storage compartment and fetching the raincoat. The rider then puts on the raincoat and restarts the vehicle to hit a road. This process normally needs at least 5 minutes. However, when many riders park the bike/scooter/motorcycle by a road side at the same time, and wear on the raincoats by the same process, traffic will be jammed severely and safety can be affected.

On the other hand, when a mountain climber is climbing a mountain or soldiers are marching, they will usually carry a large backpack and other gears. If there is unexpected heavy rain during the activities, the mountain climber or the soldiers must stop and unload the large and heavy backpacks, get the raincoats out of the backpack, and then put it on before hitting the road again. This can delay time and cause inconvenience; in addition, the body, the clothes or the gears will still get wet by the heavy rain.

In view of the above shortcomings, the applicant, having accumulated many years of experience in related arts, and following continuous research and experimentation, finally succeeded in producing a new and improved containing structure able to achieve the objective of combining multiple functions, which can also further variably apply the body-worn structure in products for pet and also for people.

### SUMMARY OF THE INVENTION

The objective of the present invention lies in providing a body-worn structure, and more particularly to a body-worn structure lies in applying a flexible enclosure connected to an expansion/retaining device with combined multiple functions to facilitate the user in meeting the various different needs for outdoor activities. The body-worn structure comprises a flexible enclosure, an exit port and a wear-on port. The flexible enclosure further includes a front breadth and rear breadth. Both the exit port and the wear-on port have an enlarged opening structure; the exit port includes a side extension port, a front opening or a shrinking piece; and the wear-on port includes a lower opening, a left opening, a right opening, or a rear opening. By the enlarged exit port and wear-on port, the distance between the exit port and the wear-on port can be decreased, so that the body-worn structure can be put on and taken off quickly. An inner side of the front breadth of the flexible enclosure is further connected with an expansion/retaining device, allowing a user to expand a coat from or fold the coat into the retaining space while wearing on the coat, so that the user can fold and contain the coat without taking off the coat completely.

Based on the aforementioned features of the structure, the expansion/retaining device includes a front cover sheet, a rear cover sheet, and a connecting portion which connects the front cover sheet with the rear cover sheet. In addition, a retaining space is formed between the front cover sheet and the rear cover sheet. The expansion/retaining device also includes a cover piece which is disposed on a periphery of the front cover sheet, and a cover assembly which is disposed on a periphery of the rear cover sheet. By the cover piece and the cover assembly, the front breadth and the rear breadth after folding can be contained in the retaining space and the retaining space is closed.

Based on the aforementioned features of the structure, upon using the body-worn structure, the left opening and the right opening are first opened by a left open-close piece, a right open-close piece, a left open-close assembly and a right open-close assembly, so that after the left opening and the right opening of the coat are opened, the left and right openings are extended to the lower opening to form a U-shaped opening, acting as the wear-on port when the user wears on the coat. By connecting the left, right openings, extending toward the lower opening, with the lower opening, the size of opening of the wear-on port can be enlarged, thereby decreasing the distance between the wear-on port and the exit port, so that the coat can be put on and taken off quickly.

Based on the aforementioned features of the structure, the flexible enclosure is further connected with a jumpsuit, wherein the jumpsuit is connected to the front breadth or the rear breadth, and the left and right openings are extended to an armpit location of a sleeve portion respectively and toward the lower opening, forming a U-shaped opening. The wear-on port is formed on a location where the jumpsuit is not connected to the front breadth or the rear breadth, so that the user can wear on and take off the flexible enclosure and the jumpsuit quickly.

Based on the aforementioned features of the structure, the rear breadth is provided with a rear opening and a back cover portion. The rear opening is extended toward the lower opening from a split location, and includes a left piece and a right piece which are split with respect to each other. In addition, an edge of the left piece is provided with an open-close piece, and an edge of the right piece is provided with an open-close assembly. The open-close piece and the open-close assembly are extended from the rear opening to the lower opening, and are connected together to form an enlarged and inverted-T opening acting as the wear-on port, so that the distance between the wear-on port and the exit port can be decreased, thereby allowing the coat to be put on and taken off quickly.

Based on the aforementioned features of the structure, the flexible enclosure is in shape of one piece of sheet material, and is bent and folded at a center to form the front breadth and the rear breadth. The left, right openings and the lower opening are connected between the front breadth and the rear breadth, and an inner side of the left and right openings is provided respectively with a fixing portion. Two ends of the fixing portion are provided respectively with a first fixing member and a first fixing assembly. Therefore, a user's wrist can be fixed on the inner sides of the left, right openings, achieving a function of a sleevelet. Besides that, a second fixing member and a second fixing assembly are disposed at locations corresponding to the first fixing member and the first fixing assembly, so that the fixing portion can be positioned on the inner side of the flexible enclosure.

Based on the aforementioned features of the structure, the front cover sheet or the rear cover sheet, vertically disposed below the connecting portion as an open end, is provided with a positioning portion opposite to the inner side of the front breadth. The positioning portion can position the front cover sheet or the rear cover sheet. The positioning portion is a pocket, and the pocket is provided with an insertion port with an upward opening, which facilitates the front cover sheet or the rear cover sheet, vertically disposed below the connecting portion, and a holding portion to be inserted from top to bottom. The pocket can catch an object which may drop out of the holding portion during operation, so as to assure that the object will not be lost and the object can be accessed conveniently.

Based on the aforementioned features of the structure, the front cover sheet or the rear cover sheet is provided with a jacket body. The jacket body is further provided with an assembly structure, so that the holding portion can be assembled or dismantled movably. The assembly structure includes a hook and loop fastener, a magnetic sheet or a snap.

Yet another objective of the present invention lies in applying the covering body in a body protective device, such as protective clothing or airbag clothing. The body protective device comprises a front cover sheet, which is a jacket formed from a front inner piece and a rear inner piece, wherein the jacket is provided with openings to enable the user to put on. The body protective device is fitted to the outer side of the jacket to enable use as an outer clothing or covering for the wearer. A containing space formed between the front cover sheet and the rear cover sheet is used to retain the folded up covering body, with fixing members and corresponding fixing members used to close up the front cover sheet and the rear cover sheet. When the body protective device is an airbag clothing, the airbag clothing comprises an inner airbag and an outer airbag. The structures of the inner and outer airbags can be either a single piece airbag or a plurality of independent airbags. Using a plurality of independent airbags as an example, each of the independent airbags is provided with an independent air chamber and a free end. When in a deflated state, the airbags assume a partial overlapping configuration, and when in an inflated state, the airbags are set upright and connected together.

Based on the aforementioned features of the structure, when applied in a body protective device, such as protective clothing or airbag clothing, the covering body mainly comprises three configurations, wherein the rear cover sheet of the first configuration further comprises a first covering piece, which is fitted to the periphery of the jacket. Moreover, the first covering piece is fitted with a front left covering piece and a front right covering piece, wherein the front left covering piece and the front right covering piece are respectively connected to a front inner piece, and are further respectively fitted with at least one fixing member and a corresponding fixing member. The covering body further comprises a front covering body, and a retaining space formed between the front inner piece and the left, right covering pieces is able to retain the folded up front covering body, as well as further close up the left, right covering pieces using the fixing members and the corresponding fixing members. In addition, the rear cover sheet further comprises a second covering piece.

Based on the aforementioned features of the structure, the rear cover sheet of the second configuration is the first covering piece corresponding to the front inner piece. The first covering piece is fitted to the periphery of the front side of the jacket, wherein the fixing members are fitted to the first covering piece, and the corresponding fixing members are fitted to the edge of the front inner piece. A retaining space formed between the front inner piece and the first covering piece is able to retain the folded up front covering body, as well as further close up the first covering piece using the fixing members and the corresponding fixing members.

Based on the aforementioned features of the structure, the rear cover sheet of the third configuration is fitted to the periphery of the front side of the jacket using the single covering piece. The single covering piece corresponds to the single inner piece, wherein the fixing members are fitted to the single covering piece, and the corresponding fixing members are fitted to the edge of the single inner piece. A retaining space formed between the single inner piece and the single covering piece is able to retain the folded up single covering body, as well as further close up the single covering piece using the fixing members and the corresponding fixing members.

Based on the aforementioned features of the structure, the covering body using a hollow spherical body or a hollow airbag of a body protective device, wherein the body protective device is provided with a plurality of support columns, which are either inflatable air cylindrical body structures or foldable elastic cylindrical bodies. In addition, the plurality of support columns are connected to either the front inner piece or the rear inner piece, and are used to support fixing the configurational shape of the exterior of the hollow spherical body or the hollow airbag. When the support columns are configured as air column structures, a connective inflating channel is provided between the air column structures and the hollow spherical body or the surface of the hollow spherical body. The surface of the hollow spherical body or the hollow airbag can be configured as a single sheet flat surface or a plurality of airbag surfaces. When the surface is configured as a plurality of airbags, an outer airbag having a plurality of independent airbag structures is adopted, with each of the independent airbags being provided with an independent air chamber and a free end. When in an deflated state, the structure assumes a partial overlapping configuration, and when in an inflated state, the airbags are set upright and connected together. The hollow spherical body or the hollow airbag either comprise at least front cover sheets or rear cover sheets, and further comprise at least one joining opening. The joining opening is formed from the joining of two joining ends, and the joining opening is provided with a sealing member.

Based on the aforementioned features of the structure, the body protective device comprises either an air supply, a manual inflating device, or an automatic inflating device. In an emergency situation, the jacket wearer can carry out a manual inflation operation. The automatic inflating device is fitted with a synchronous start switch, a sensor, and a manual changeover switch. In an emergency situation, the sensor transmits a signal to the synchronous start switch to open a fourth valve to channel in air from the air supply, thereby enabling achieving the objective of inflating the airbags. Under certain conditions, when the sensor malfunctions or is inappropriate to auto-start, the manual changeover switch can be used to control the fourth valve. In addition, the body protective device can further comprise a global satellite positioning device, which is connected to the synchronous start switch and the sensor. In an emergency situation, the sensor can automatically transmit a satellite positioning signal to facilitate rescuing the accident victim.

Based on the aforementioned features of the structure, the body protective device of the present invention has application in activities including mountain-climbing and skiing, use as a safety airbag when riding a motorcycle, in water activities such as boating, and aerial activities such as hand gliding or paragliding, or after pairing with essential life support equipment, can also be further applied in safety equipment for passengers travelling by airplane. According to the criteria required for each of the activities described above (such as: temperature, speed, altitude, pressure, impact force, etc.) the sensor can be set to transmit the appropriate signal to the synchronous start switch and when to transmit the signal.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 and FIG. 2 show schematic views of a folding procedure, according to a first embodiment of the present invention.

FIG. 3 shows a front structural view of an embodiment of the present invention at an expanded condition.

FIG. 4 shows a rear structural view of the embodiment of the present invention at the expanded condition.

FIG. 5 shows a schematic view of a folding procedure according to the second embodiment of the present invention.

FIG. 6 shows a schematic view of a shoulder bag formed by a front cover sheet and a rear cover sheet, according to the present invention.

FIG. 7 shows an exploded view of a further embodiment of the present invention at an expanded condition.

FIG. 8 and FIG. 9 show schematic views of the further embodiment of the present invention at the expanded condition.

FIG. 10 shows a schematic view of the folding procedure, according to the third embodiment of the present invention.

FIG. 11 and FIG. 12 show schematic views of the further embodiment of the present invention at an expanded condition.

FIG. 13 and FIG. 14 show schematic views of the folding procedure, according to the fourth embodiment of the present invention.

FIG. 15 and FIG. 16 show schematic views for the movements when carrying out the expanding procedure according to the present invention.

FIG. 16A and FIG. 16B show partial enlarged views of FIG. 16.

FIG. 17 shows a schematic view of the expanding operation when being applied to a vest according the fourth embodiment of the present invention.

FIG. 18 shows a partial exploded view when being applied to a movable holding portion according to the present invention.

FIGS. 19 and 20 show schematic views of the covering body applied in the embodiment of an airbag clothing covering piece for the body protective device.

FIGS. 21 and 22 show lengthwise sectional schematic views of the covering body applied in the embodiment of an airbag clothing covering piece for the body protective device.

FIG. 23 is a perspective structural schematic view of the present invention applied in the embodiment of the airbag clothing covering piece of the body protective device.

FIG. 24 is a partial lengthwise sectional view of FIG. 23 according to the present invention.

FIG. 25 is a partial structural schematic view of FIGS. 21 and 22 according to the present invention.

FIG. 26 is a cross-sectional structural schematic view of the covering body applied in the embodiment of a hollow spherical body for a body protective device.

FIG. 27 is a lengthwise sectional structural schematic view of the covering body applied in the embodiment of the hollow spherical body for the body protective device.

FIG. 28 is a cross-sectional schematic view of a first configurational embodiment of the airbag clothing covering piece applied in the body protective device.

FIG. 29 is a cross-sectional schematic view of a second configurational embodiment of the airbag clothing covering piece applied in the body protective device.

FIG. 30 is a cross-sectional structural schematic view of a third configurational embodiment of the airbag clothing covering piece applied in the body protective device.

FIG. 31 is an exploded structural schematic view of the covering body applied in the body protective device according to the present invention.

FIG. 32 is an operational flow diagram of the covering body applied in the body protective device according to the present invention.

FIG. 33 is a schematic view of the covering body applied in the body protective device during an outdoor emergency situation.

### DETAILED DESCRIPTION OF THE PREFERRED EMBODIMENTS

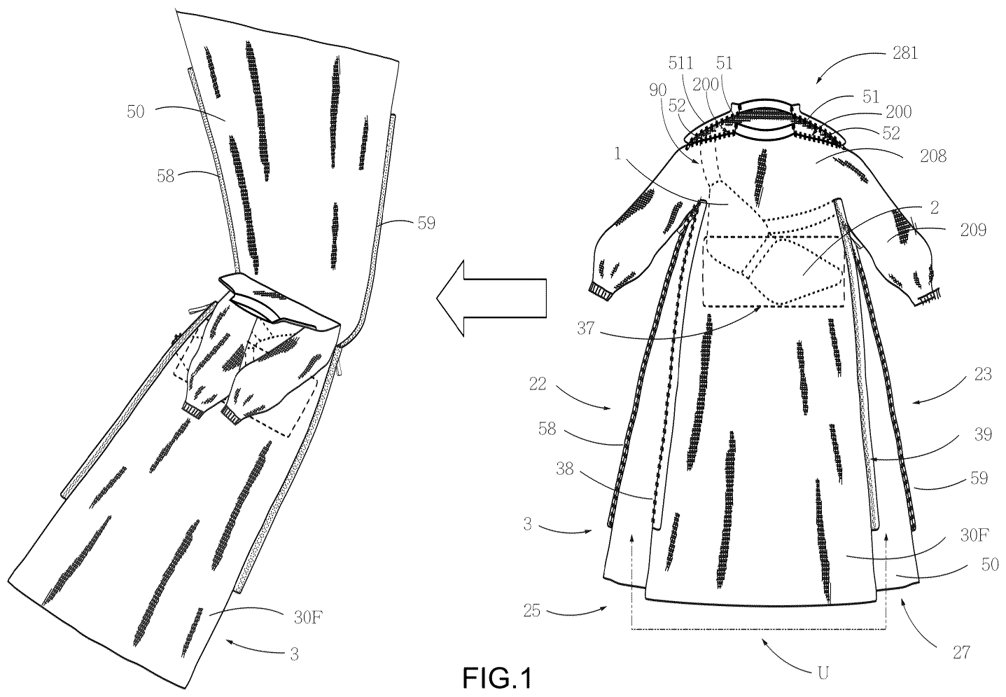

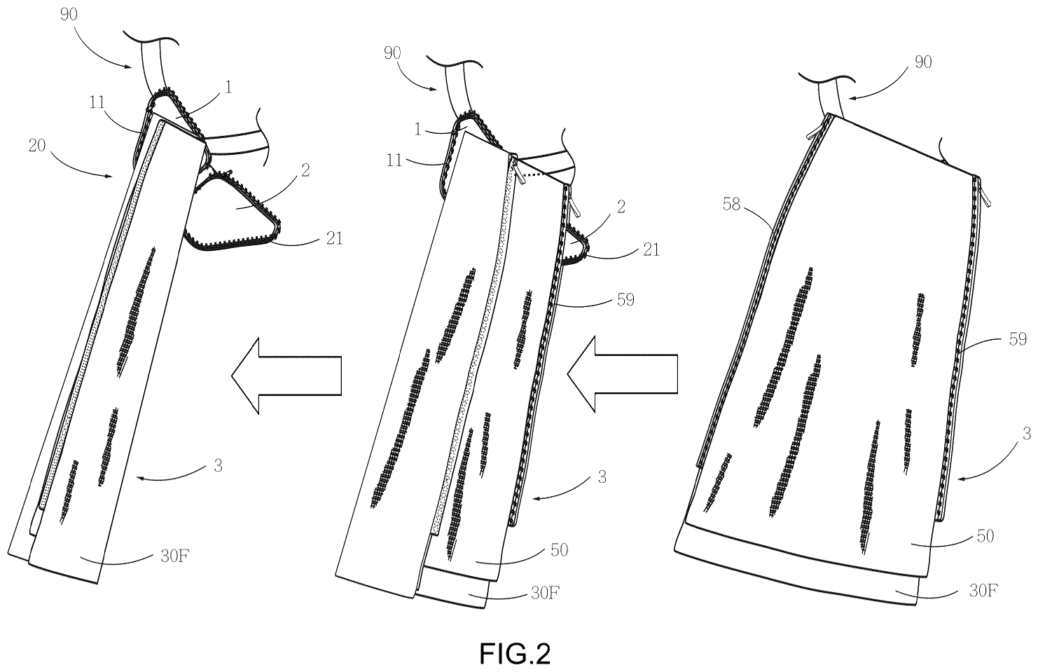

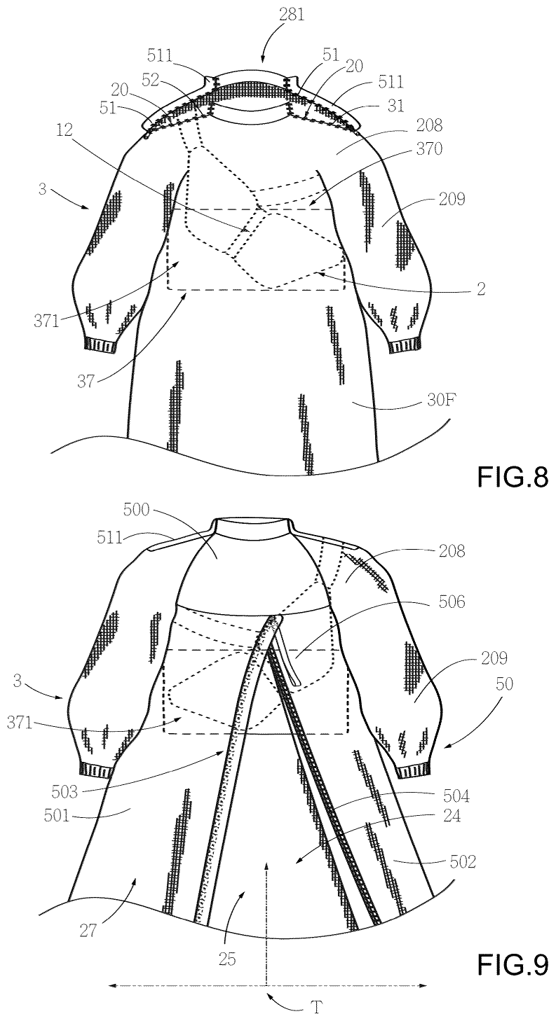

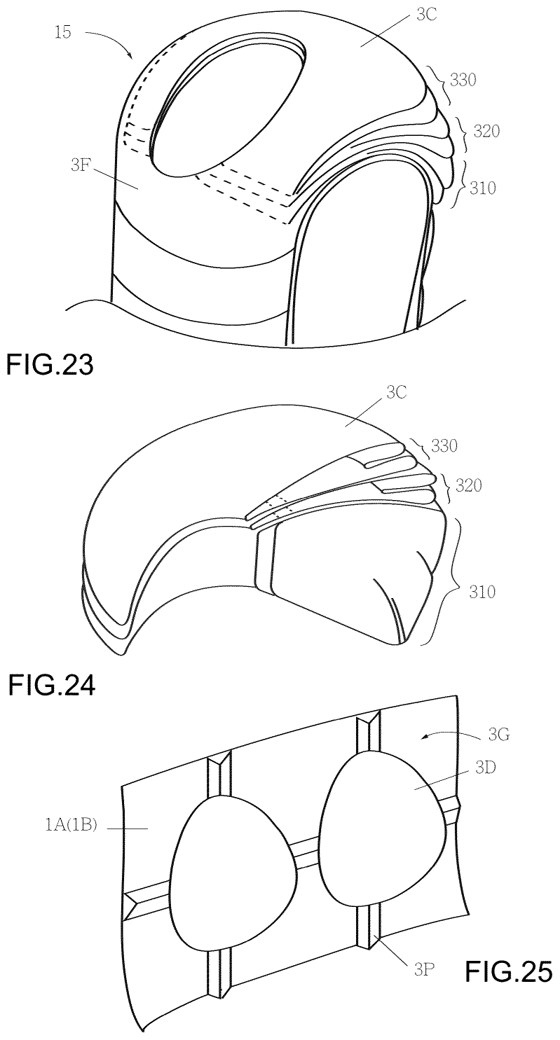

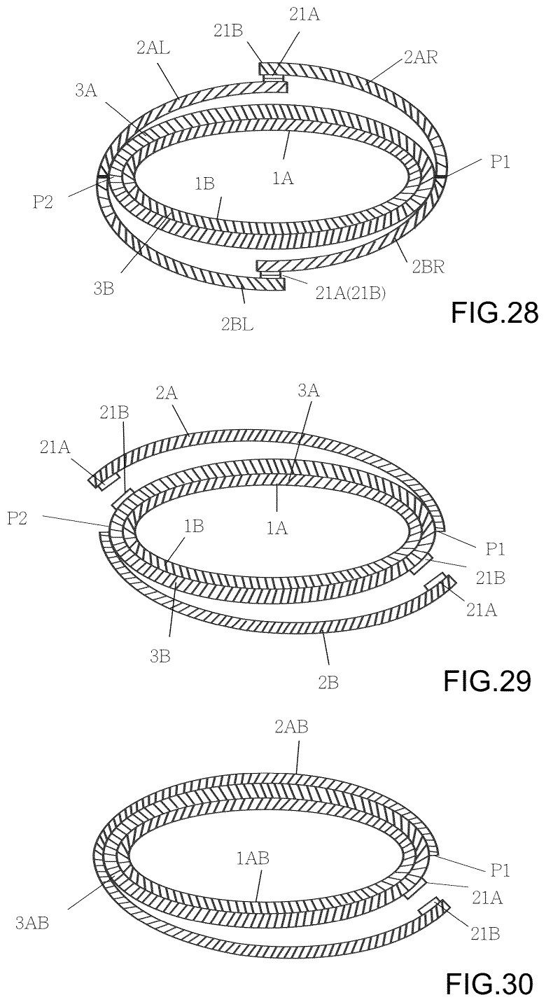

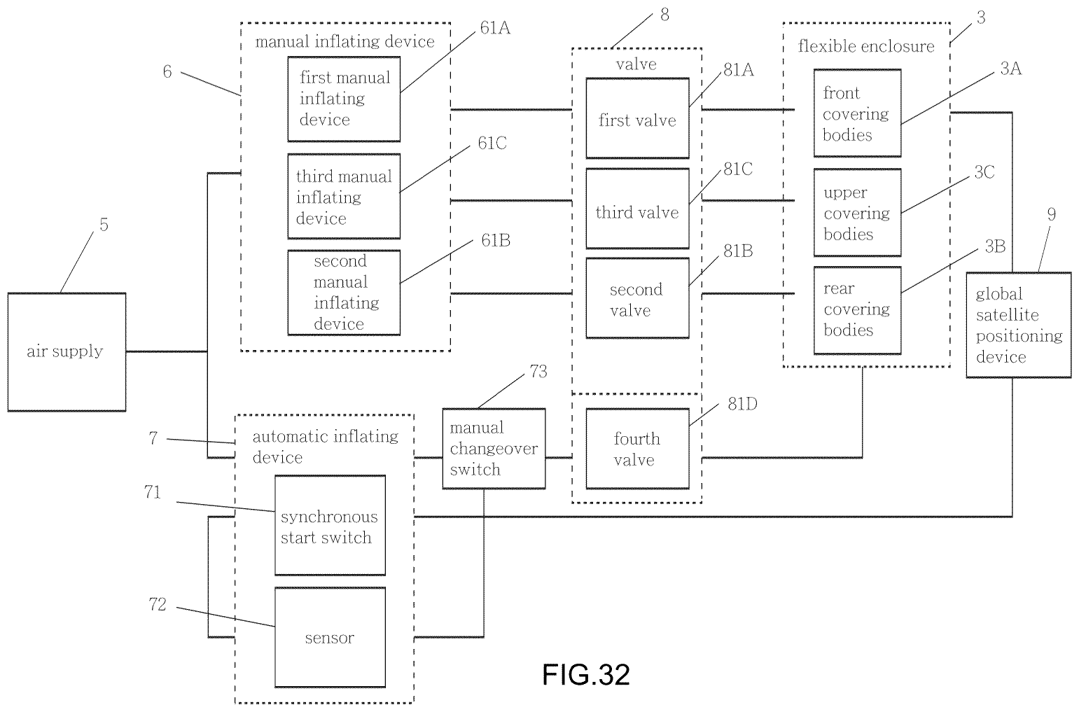

Referring to FIG. 1 to FIG. 40, which show a first embodiment of the rain outfit structure, comprising a flexible enclosure 3 constituted by a front breadth 30F and a rear breadth 50, a wear-on port 27 and an exit port 28. The wear-on port 27 includes a left opening 22, a right opening 23 and a lower opening 25. The exit port 28 is disposed above a space between the front breadth 30F and the rear breadth 50. The flexible enclosure 3 further includes two shoulder portions 208 and two sleeve portions 209. The exit port 28 is extended toward the shoulder portions 208 and the sleeve portions 29 from left and right, and the left and right sides of the exit port 28 include a side extension port 200 respectively. A left and right side of the side extension port 200 on an edge of the front breadth 30F is provided respectively with an upper open-close piece 52, and the left and right side of the side extension port 200 on an edge of the rear breadth 50 is provided respectively with an upper open-close assembly 51. As shown in the drawing, the present embodiment takes a cape-like raincoat as an example. As the exit port 28 is provided with a structure that extends rightward and leftward, when the exit port 28 is combined with the side extension ports 200 and is completely opened, the aperture of the exit port 28 can be configured to be twice large as a diameter of a helmet that is worn on a user's head. Therefore, when there is unexpected heavy rain, the user can quickly put on or take off the coat without taking off the helmet.

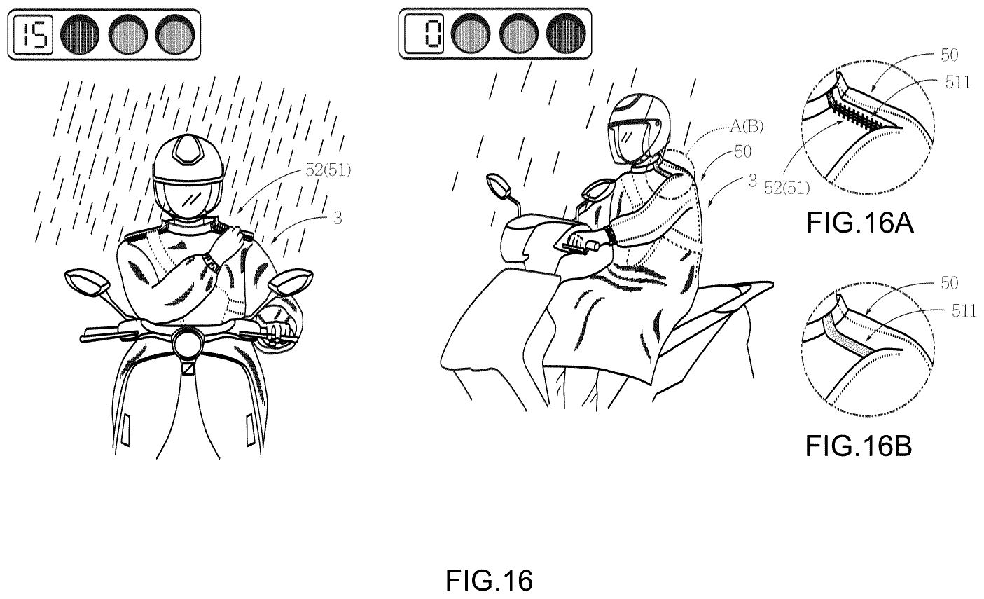

Referring to FIG. 16A and FIG. 16B at a same time, the rear breadth 50 of a raincoat is provided with an upper covering strip 511 above the upper open-close piece 52 and the upper open-close assembly 51. The upper open-close piece 52 and the upper open-close assembly 51 are disposed on a height of the shoulder of the user, an opening between the upper open-close piece 52 and the upper open-close assembly 51 is toward a lower front of the shoulder obliquely, and the area of the upper covering strip 511 is larger than the area of the combination of the upper open-close piece 52 and the upper open-close assembly 51; therefore, by that the upper covering strip 511 covers toward the lower front direction, even the heavy rain impinges on the upper covering strip 511, the rain will slide down instantly, without seeping into the gap between the upper open-close piece 51 and the upper open-close assembly 51.

Moreover, the left and right openings 22, 23 are disposed on a left side and a right side between the front breadth 30F and the rear breadth 50, the left and right openings 22, 23 are extended toward the lower opening 25 from an armpit location below the sleeve portions 209, and edges of the front breadth 30F and the rear breadth 50 at the left and right openings 22, 23 are provided with a left open-close piece 38, a left open-close assembly 58, a right open-close piece 39, and a right open-close assembly 59. Upon using the body-worn structure, the left open-close piece 38, the left open-close assembly 58, the right open-close piece 39, and the right open-close assembly 59 are opened first. Therefore, a U-shaped opening U (as shown in FIG. 38) is formed by connecting the left, right sides to the lower side of the raincoat or coat, acting as the wear-on port 27. In the present embodiment, by the left and right openings 22, 23 that connect the lower opening 25, the opening size of the wear-on port 27 can be enlarged, so as to decrease the distance between the wear-on port 27 and the exit port 28, thereby allowing the user to put on or take off the raincoat or coat quickly.

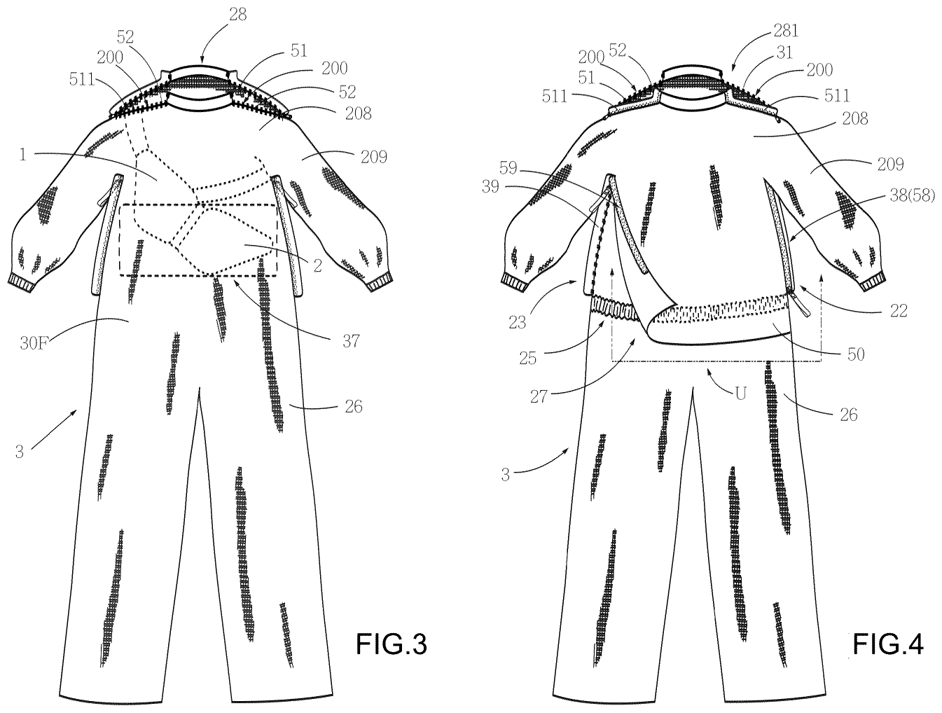

Referring to FIGS. 3 to 5, which show a second embodiment of the rain outfit structure, comprising a flexible enclosure 3 constituted by a front breadth 30F and a rear breadth 50, an exit port 28, a left opening 22, a right opening 23 and a lower opening 25. The exit port 28 is disposed above a space between the front breadth 30F and the rear breadth 50. The flexible enclosure 3 further includes two shoulder portions 208 and two sleeve portions 209. The left and right sides of the exit port 28 include a side extension port 200 respectively, and the side extension port 200 is extended toward the shoulder portions 208 and the sleeve portions 209 from the left and right sides of the exit port 28. A left and right side of the side extension port 200 on an edge of the front breadth 30F is provided respectively with an upper open-close piece 52, and the left and right side of the side extension port 200 on an edge of the rear breadth 50 is provided respectively with an upper open-close assembly 51. As shown in the drawing, the present embodiment is a structure that combines the flexible enclosure 3 with a jumpsuit 26. The exit port 28 of the present embodiment is the same as that in the first embodiment, i.e., a structure that extends leftward and rightward. Therefore, when the exit port 28 is combined with the side extension ports 200 and is opened completely, an automobile rider can put on or take off the coat quickly without taking off the helmet in heavy rain while riding an automobile. In addition, the rear breadth 50 is provided with an upper covering strip 511 above the upper open-close piece 52 and the upper-close assembly 52, which can achieve the same rain-proofing effect as described in the first embodiment.

The present embodiment is different from the first embodiment in that the front breadth 30F or the rear breadth 50 of the present embodiment is connected with a jumpsuit 26, wherein the wear-on port 27 is formed at a location where the front breadth 30F or the rear breadth 50 is not completely connected with the jumpsuit 26, and the wear-on port 27 is exactly at a U-shaped opening U that is formed by the left, right openings 22, 23 extending to an armpit location below the sleeve portions 209 and toward the lower opening 25. Therefore, this U-shaped opening U is the wear-on port 27 for both the jumpsuit 26 and the flexible enclosure 3. In addition, edges of the front breadth 30F and the rear breadth 50 at the left, right openings 22, 23 are provided respectively with a left open-close piece 38, a left open-close assembly 58, a right open-close piece 39 and a right open-close assembly 59. Upon using the present embodiment, the left open-close piece 38, the left open-close assembly 58, the right open-close piece 39, and the right open-close assembly 59 are opened first. By using the enlarged U-shaped opening U (as shown in FIG. 4) as the wear-on port 27, the distance between the wear-on port 27 and the exit port 28 is decreased, thereby allowing the user to put on or take off the flexible enclosure 3 and the jumpsuit 26 quickly.

The rain outfit structure, comprises a flexible enclosure 3 constituted by a front breadth 30F and a rear breadth 50, an exit port 28, a rear opening 24, a lower opening 25 and a back cover portion 500. The exit port 28 is disposed above a space between the front breadth 30F and the rear breadth 50. The flexible enclosure 3 includes two shoulder portions 208 and two sleeve portions 209. A left and right side of the exit port 28 includes a side extension port 200 which is extended toward the shoulder portions 208 and the sleeve portions 209 via the left and right side of the exit port 28. A left and right side of the side extension port 200 on an edge of the front breadth 30F is provided respectively with an upper open-close piece 52; whereas, the left and right side of the side extension port 200 on an edge of rear breadth 50 are provided respectively with an upper open-close assembly 51. As shown in the drawing, the present embodiment is a cape-like raincoat, and the exit port 28, the upper open-close piece 52, the upper open-close assembly 51, and the upper covering strip 511 are the same as that described in the first and second embodiments in terms of structures and functions; therefore, no further description is provided.

The present embodiment is different from the first and second embodiments in that the rear opening 24 of the present embodiment is disposed on the rear breadth 50, including a left piece 501 and a right piece 502 which are split with respect to each other. In addition, the rear opening 24 is extended toward the lower opening 25 from a central split location. An edge of the left piece 501 is provided with an open-close piece 503, and an edge of the right piece 502 is provided with an open-close assembly 504 correspondingly. A pull-back piece 506 is disposed between the open-close piece 503 and the open-close assembly 504. In wearing the present embodiment, the open-close piece 503 and the open-close assembly 504 are first pulled by the pull-back piece 506 to open the rear opening 24. Then, the user can first sheath in the head from the rear opening 24, and sheath the head out of the exit port 28. For the raincoat or the coat, an inverted-T opening T is formed by connecting the rear opening 25 to the lower opening 25 to act as the wear-on port 27, so that the opening size of the wear-on port 27 can be enlarged, thereby decreasing the distance between the wear-on port 27 and the exit port 28 and thus achieving the effect that the raincoat or coat can be put on or taken off quickly.

In the present embodiment, the back cover portion 500 is disposed above the rear opening 24, and an upper edge of the back cover portion 500 is connected with an upper edge of the rear breadth 50; whereas, a lower edge of the back cover portion 500 covers on the split rear opening 24 in an open-end condition, forming a rain-stopping rear baffle like an eave. Therefore, in heavy rain, rain impinges on the back cover portion 500 from top to bottom, and then slides downward, which further intensifies the rain-proofing effect of preventing rain from seeping into the gap between the open-close piece 503 and the open-close assembly 504.

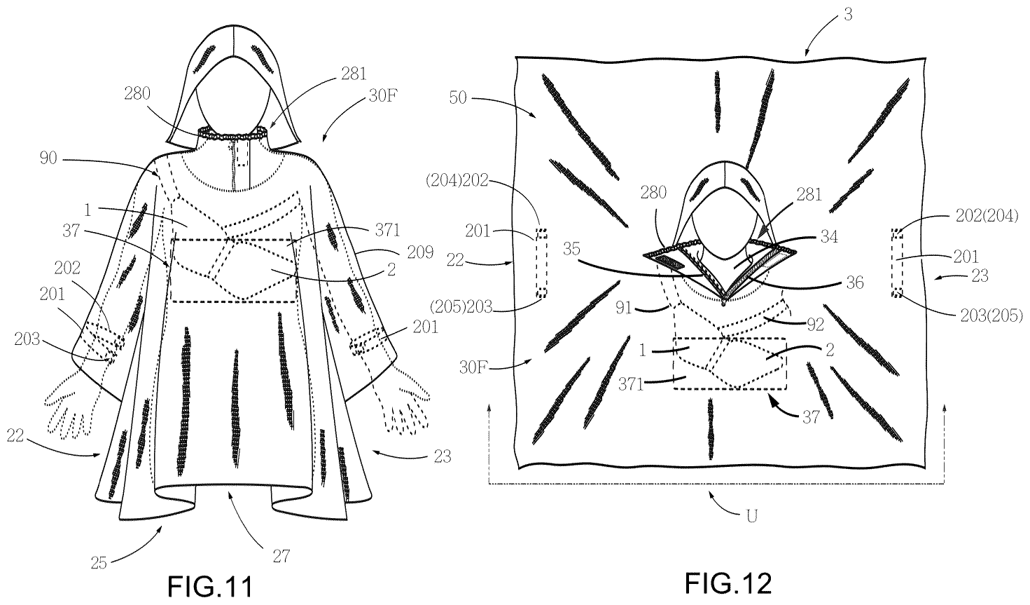

Referring to FIGS. 11 to 14, a further embodiment of present invention applied in rain outfit structure comprises a flexible enclosure 3 constituted by a front breadth 30F and a rear breadth 50, a wear-on port 27 and an exit port 28. The wear-on port 27 includes a left opening 22, a right opening 23 and a lower opening 25. The flexible enclosure 3 is in shape of one piece of sheet material, and a central location of the flexible enclosure 3 is bent and folded to form the front breadth 30F and the rear breadth 50. The exit port 28 is disposed above a space between the front breadth 30F and the rear breadth 50. The left and right openings 22, 23 are disposed on a left side and a right side between the front breadth 30F and the rear breadth 50, are extended toward the lower opening 25 from an armpit location below the sleeve portions 209, and are connected together between the front breadth 30F and the rear breadth 50 to form a U-shaped opening U. This U-shaped opening U acts as the wear-on port 27.

The exit port 28 is provided with a front opening 34 on the front breadth 30F, edges on two sides of the front opening 34 are provided respectively with a front open-close piece 35 and a front open-close assembly 36, so that the front opening 34 can be opened or closed. In wearing the present embodiment, the user can first sheath in the head from the U-shaped opening U, and then sheath the head out of the exit port 28. By the enlarged U-shaped opening U, the distance between the wear-on port 27 and the exit port 28 can be decreased, thereby allowing the user to put on or take off the raincoat or coat quickly. The exit port 28 in the present embodiment can be also configured as the upper open-close piece 52 and the upper open-close assembly 51 as described in the first to third embodiment, and is used as a substitute for the front open-close piece 35 and the front open-close assembly 36.

A periphery of the exit port 28 can be also provided with a shrinking piece 280 to facilitate restoring the exit port 28 to the size of an ordinary neckline by the extension function of the shrinking piece 280 after the helmet is sheathed out of the exit port 28, when the user wears on the present embodiment. The shrinking piece 280 includes an elastic ribbon, a contraction band or a collecting element associated with a rope (these are all conventional structures and thus are not shown in the drawings). Besides that, the exit port 28 can be further combined with the front opening 34. Therefore, when the exit port 28, associated with the front opening 34, is fully opened, the aperture of the exit port 28 can be double or even larger than the diameter of the coat after the user wears on a helmet, so that the user can quickly put on or take off the coat without taking off the helmet. In addition to being applied to the present embodiment, the abovementioned shrinking piece 280 that is disposed on the periphery of the exit port 28 can be also combined in and applied to the first to third embodiment described above to assist the open-close function.

Accordingly, as the flexible enclosure 3 of the present embodiment is in shape of one piece of sheet material structure before folding, inner sides of the left and right openings 22, 23 are provided respectively with a fixing portion 201, and two ends of the fixing portion 201 are provided respectively with a first fixing member 202 and a first fixing assembly 203, so that a wrist of the user can be fixed on the inner sides of the left and right openings 22, 23 (as shown in FIG. 11).

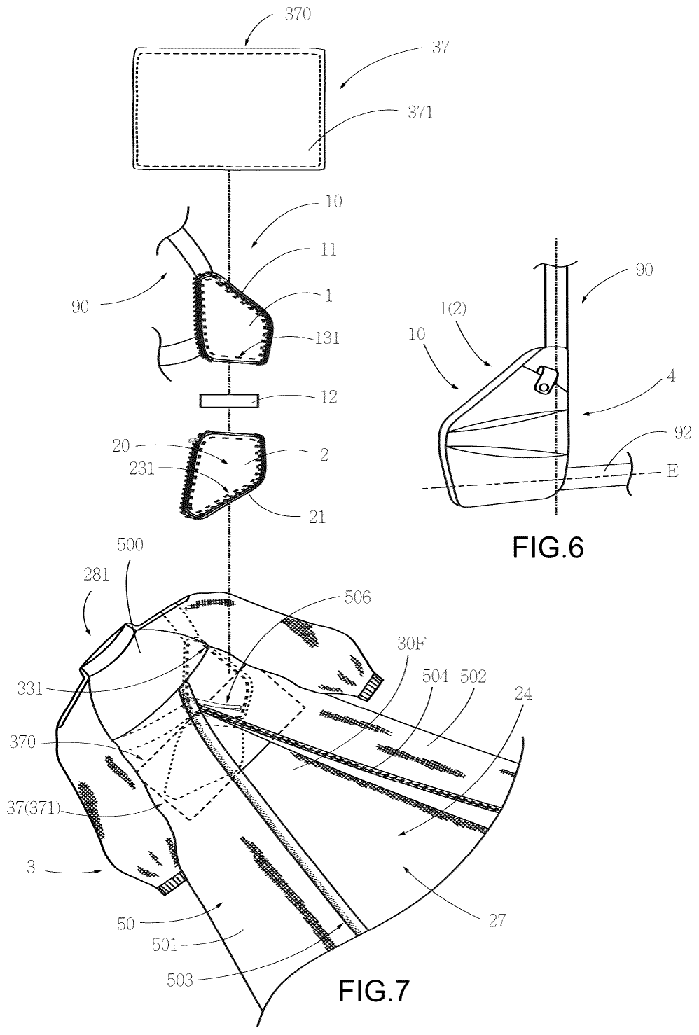

Opposite to the first fixing member 202 and the first fixing assembly 203, an inner side of the one-piece-like flexible enclosure 3 in the present embodiment is provided with a second fixing member 204 and a second fixing assembly 205. When the fixing portion 201 is not used, by matching the second fixing member 204 and the second fixing assembly 205 with the first fixing member 202 and the first fixing assembly 203, the fixing portion 201 can be positioned on the inner side of the flexible enclosure 3.
1. Referring to FIG. 6 and FIG. 7, and related drawings of the first to fourth embodiment, the present invention can be further combined with an expansion/retaining device 10 constituted by a front cover sheet 1 and a rear cover sheet 2. The front cover sheet 1 and the rear cover sheet 2 are connected together by a connecting portion 12, the front cover sheet 1 is provided with a first joining edge 131, and the rear cover sheet 2 is provided with a second joining edge 231. An inner side of the front breadth 30F is provided with a third joining edge 331, and the front cover sheet 1 or the rear cover sheet 2 can be connected with the third joining edge 331 on the inner side of the front breadth 30F by the first and second joining edges 131, 231. As shown in the drawings, the present embodiment uses the first joining edge 131 of the front cover sheet 1 to connect with the third joining edge 331 of the front breadth 30F; therefore, the rear cover sheet 2 that is not connected with the front breadth 30F is vertically suspended below the connecting portion 12 as an open end. The front cover sheet 1 or the rear cover sheet 2 is provided at least with a shoulder strap 90, and a retaining space 20 is formed between the front cover sheet 1 and the rear cover sheet 2. A cover piece 11 is disposed on the periphery of the front cover sheet 1, corresponding to a cover assembly 21 disposed on the periphery of the rear cover sheet 2. By the cover piece 11 and the cover assembly 21, the front breadth 30F and the rear breadth 50F, after being folded, can be contained in the retaining space 20 and the retaining space 20 is closed. The expansion/retaining device 20 can also be flexibly disposed on the inner side of the front breadth coupling with flexible fixing members including conventional zippers or magnetic components (not shown in the drawings).

Furthermore, the front cover sheet 1 or the rear cover sheet 2 that is vertically suspended below the connecting portion 12 as an open end is provided with a positioning portion 37 opposite to the inner side of the front breadth 30F, and the positioning portion 37 includes all kinds of structures that can position the front cover sheet 1 or the rear cover sheet 2, such as a hook and loop fastener, a snap latch, a magnetic buckle, a fixing strap or a pocket. As shown in the drawings, a pocket 371 is provided with an insertion port 370 with an upward opening, allowing the front cover sheet 1 or the rear cover sheet 2 that is vertically suspended below the connecting portion 12 as an open end to be put into the pocket 371 from top to bottom. The pocket 371 can further catch an object that may drop out of a holding portion 4 when the holding portion 4 flips up and down along with the front cover sheet 1 or the rear cover sheet 2, during the expansion operation of the body-worn structure. This can assure that the contained object will not be lost, and can even allow the user to access the object in the holding portion 4 conveniently while the coat is put on the user.

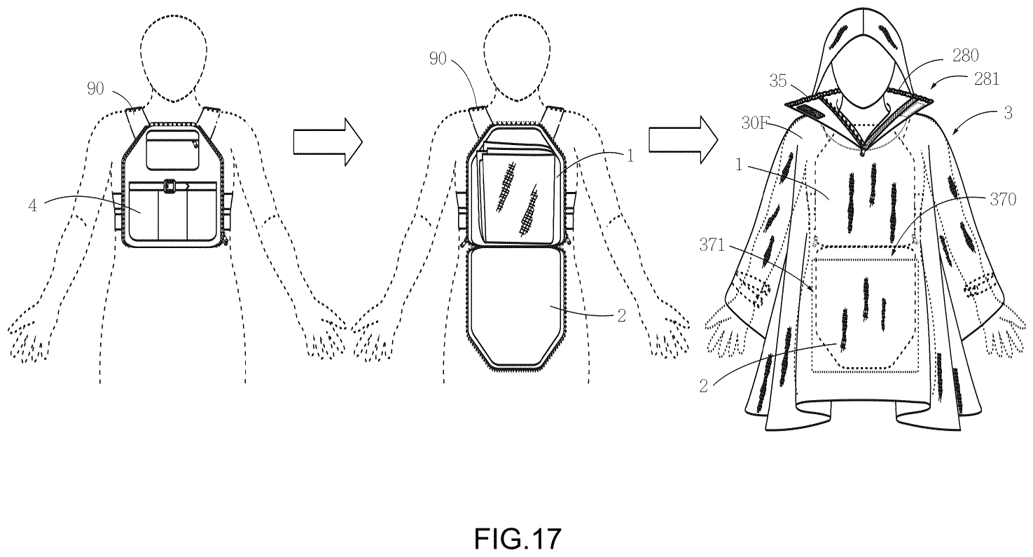

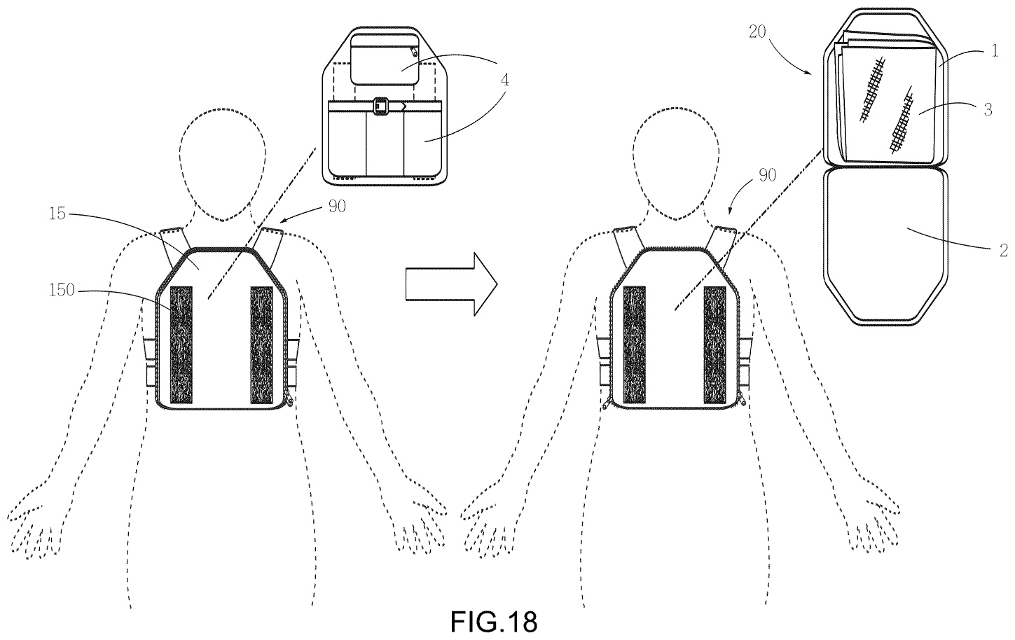

Referring to FIG. 6, FIG. 7, FIG. 17 and FIG. 18 at a same time, the front cover sheet 1 and the rear cover sheet 2 are combined into a shoulder bag (as shown in FIG. 6 and FIG. 7) through the connecting portion 12. In addition, the front cover sheet 1 or the rear cover sheet 2 is provided with the holding portion 4 to put the required personal belongings.

The expansion/retaining device 10 disclosed in the related drawings of the first to fourth embodiment takes primarily a shoulder bag in FIG. 6 and FIG. 7 as an example, describing the joining structure between the front, rear cover sheets 1, 2 and the flexible enclosure 3 (front breadth 30F and rear breadth 50) and the function thereof. However, as shown in FIG. 17 and FIG. 18, the front cover sheet 1 and the rear cover sheet 2 can be also configured as a jacket body 15 (vest), and the jacket body 15 is further provided with an assembly structure 150 (as shown in FIG. 18), so that the holding portion 4 can be assembled or dismantled movably for use.

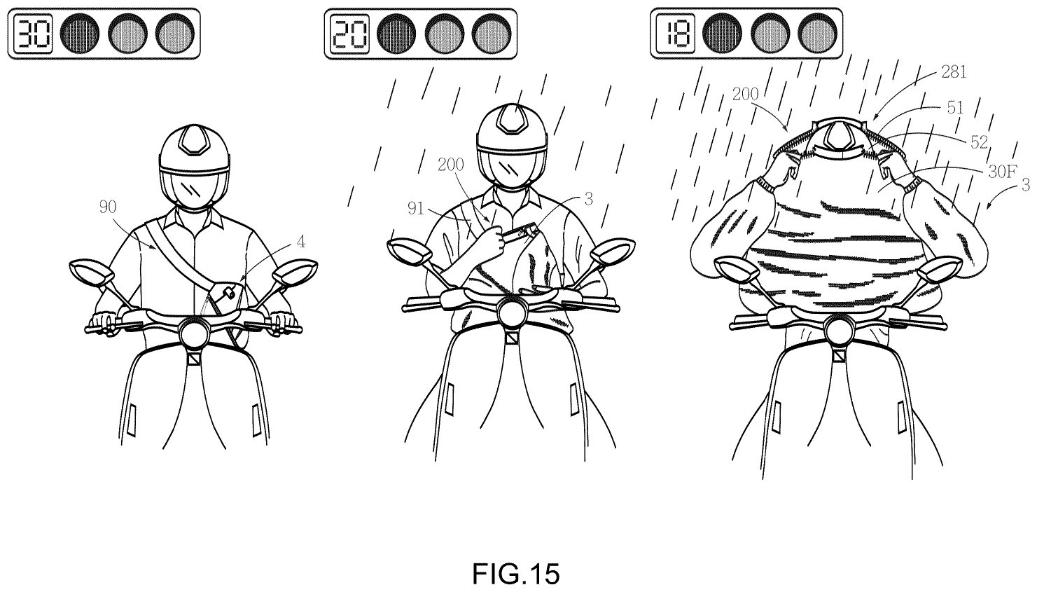

By the abovementioned structures, the embodiments as applied in the present invention can achieve the effect of putting on or taking off a coat quickly within a minimal time limit. As shown in FIG. 15 and FIG. 16, when the user rides a scooter or motorcycle in a rainy season and there is an unexpected heavy rain, the user can stop the scooter or motorcycle at a traffic light, and keep the original riding posture (30-second drawing). He or she first moves the shoulder bag from a side of the body to a chest (20-second drawing), expands the flexible enclosure 3 (cape-like raincoat) from the retaining space 30 of the shoulder bag constituted by the front and rear cover sheets 1, 2, and sheaths the head from top to bottom via the exit port 28 (18-second drawing), and finally closes the left and right side of the exit port 28 by the upper open-close pieces 52 at the left and right side on the edge of the front breadth 30F, and the upper open-close assemblies 51 at the left and right side on the edge of the rear breadth 50 (15-second drawing). Therefore, the user can expand the raincoat in the shoulder bag and wear it on in the shortest time (0-second drawing), without the need to park the scooter/motorcycle, get off scooter/motorcycle, take the raincoat out of the storage compartment, and then put it on, like using a conventional raincoat. Therefore, the traffic will not be interfered and the safety will not be affected.

For the first to fourth embodiment of the present invention, as each one has its own structural features, the folding method of each embodiment will be different too. The operating procedure of folding the outfit in each embodiment into the expansion/retaining device 10 while the user wears on the outfit is described below.

For the first embodiment, step (a) is to open the exit port 28 by the upper open-close pieces 52 and the upper open-close assemblies 51; step (b) is to open the left and right openings 22, 23 by the left open-close pieces 38, the left open-close assemblies 58, the right open-close pieces 39, and the right open-close assemblies 59; step (c) is that the user puts the head and the body out of the U-shaped opening U via the exit port 28; step (d) is to flip the rear breadth 50 toward the front breadth 30F (as shown in FIG. 38), and then cover the rear breadth 50 on the front breadth 30F; and step (e) is to fold the front breadth 30F, along with the rear breadth 50, into a long strip (as shown in FIG. 39).

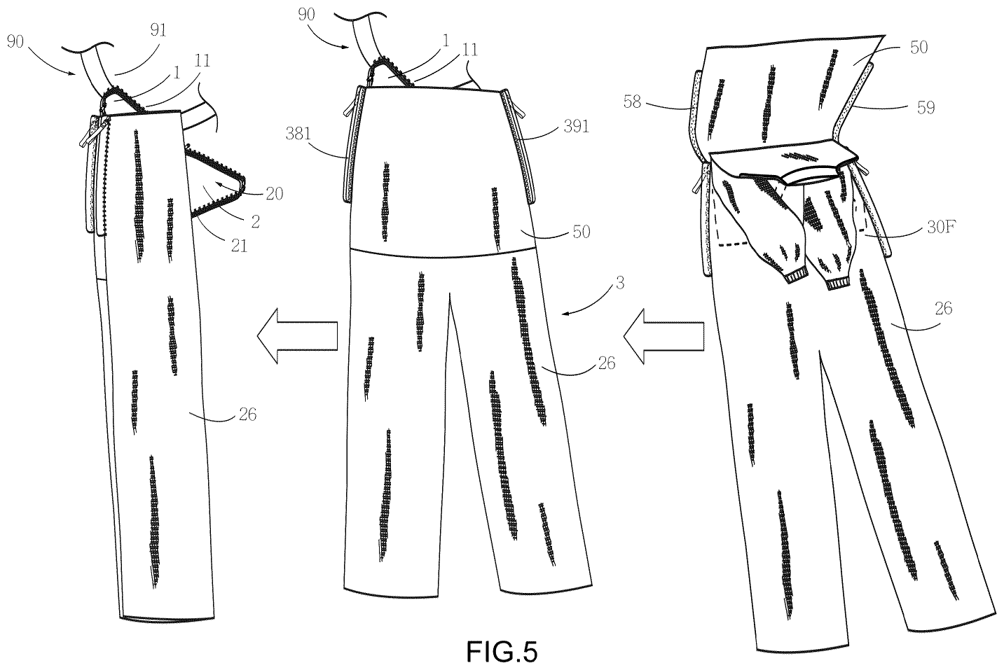

For the second embodiment, steps (a), (b), (c), and (d) are the same as that in the first embodiment; whereas, step (e) is to fold the front breadth 30F and the rear breadth 50, along with the jumpsuit 26, into a long strip (as shown in FIG. 5).

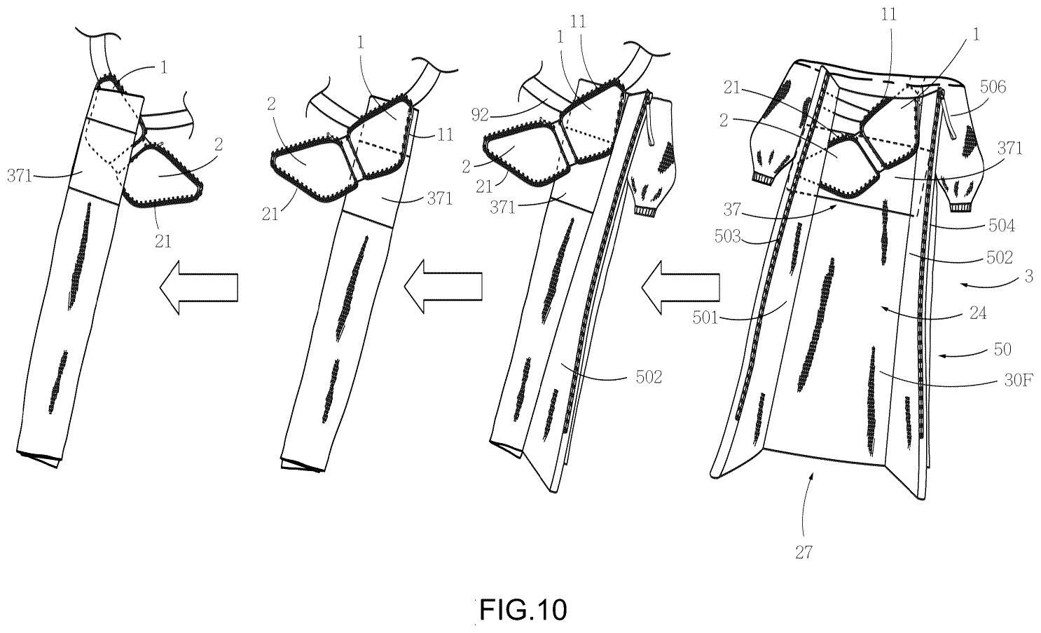

For the third embodiment, step (a) is to open the exit port 28 by the upper open-close pieces 52 and the upper open-close assemblies 51; step (b) is to open the rear opening 24 by using the pull-back piece 506 to pull the open-close pieces 503 and the open-close assemblies 504; step (c) is to open the left piece 501 and the right piece 502 toward the left and right side from the rear opening 24; step (d) is that the user puts the head and the body out of the rear opening 24 via the exit port 28; and step (e) is to fold the opened left and right pieces 501, 502 forward, and then fold the left and right pieces 501, 502 into a long strip (as shown in FIG. 10).

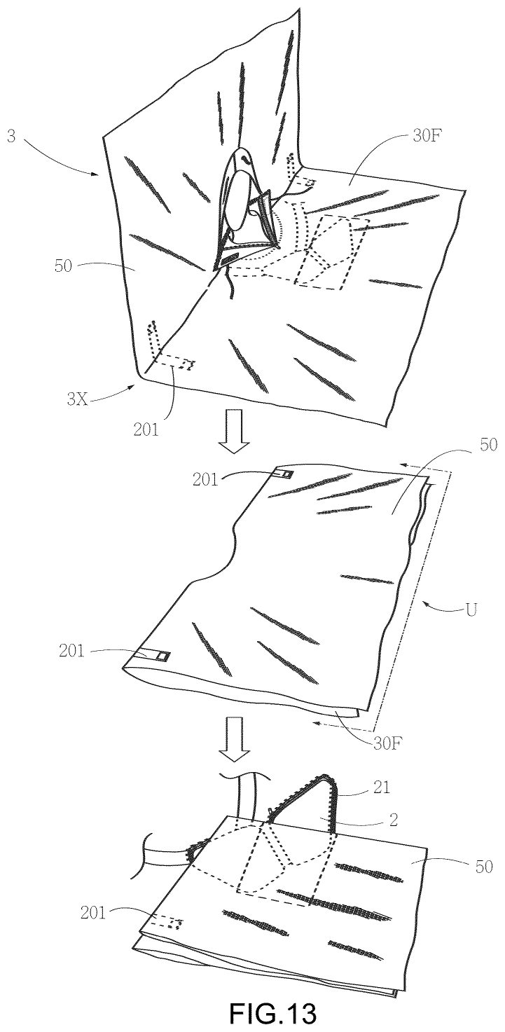

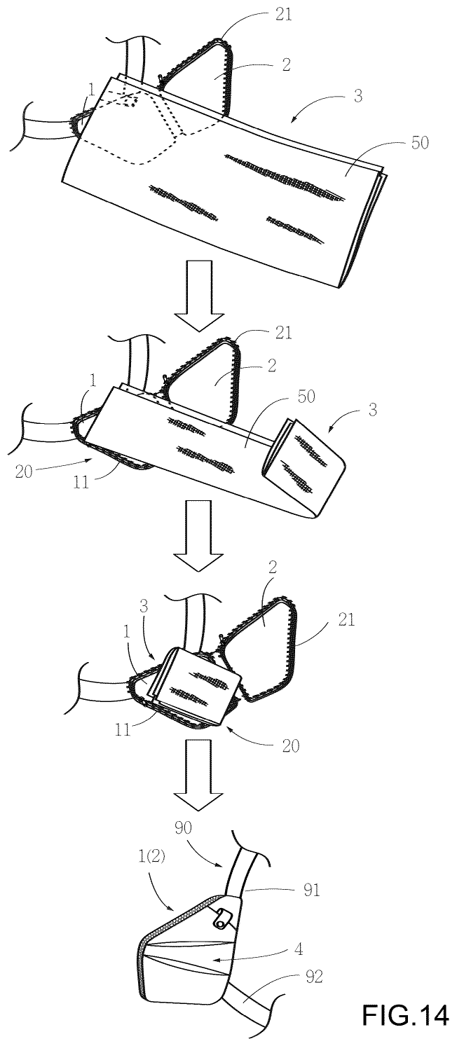

For the fourth embodiment, step (a) is to open the front opening 34 by the front open-close pieces 35 and the front open-close assemblies 36; step (b) is that the user puts the head and the body out of the U-shaped opening U via the exit port 28; step (c) is to fold the rear breadth 50 toward the front breadth 30F, and cover the rear breadth 50 on the front breadth 30F, folding into a half of overlapping condition; step (d) is to fold the front breadth 30F, along with the rear breadth 50, into a quarter of overlapping condition (as shown in FIG. 13); and step (e) is to fold the front breadth 30F and the rear breadth 50 that have been folded into the quarter of overlapping condition into a long strip (as shown in FIG. 14).

The steps (a) to (e) are different for the abovementioned first to fourth embodiment; however the following steps (f) and (g) are the same for the first to fourth embodiment. Step (f) is to roll and fold the flexible enclosure 3 that has been folded into the long strip into the retaining space 20 formed between the front cover sheet 1 and the rear cover sheet 2, so as to form the flexible enclosure 3 that fits the size of the holding portion 4; and step (g) is to contain the front breadth 30F and the rear breadth 50 that have been folded into the retaining space 20 by the cover piece 11 and the cover assembly 21, and then close the retaining space 20.

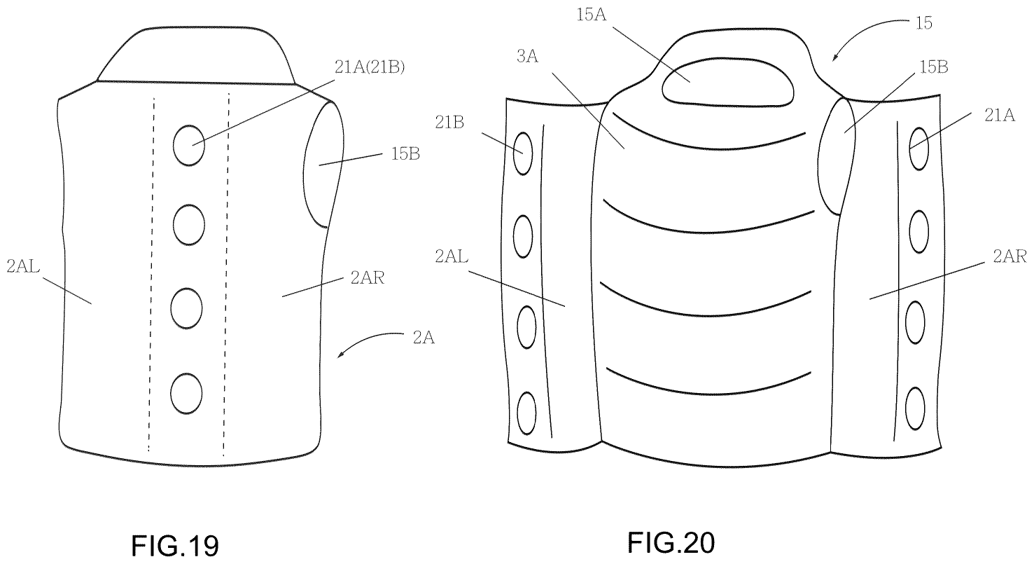

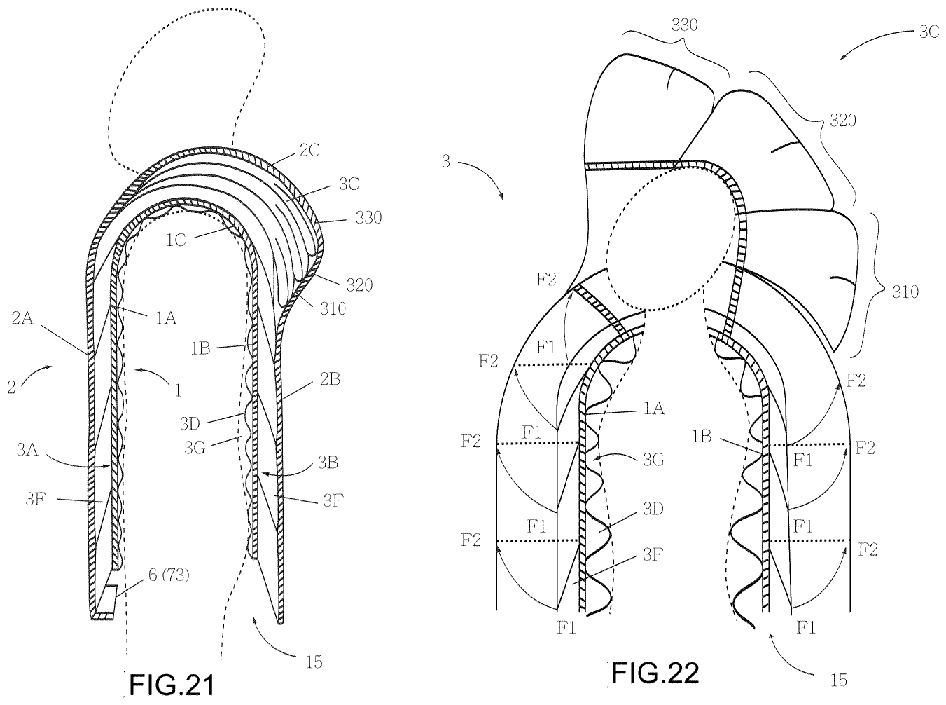

Referring to FIGS. 19 to 25, which show an embodiment of the present invention applied in a covering body for a body protective device, such as a protective clothing or an airbag clothing. The body protective device comprises the front cover sheet 1, which is a jacket 15 formed from a front inner piece 1A and a rear inner piece 1B (see FIGS. 21 and 22), wherein the jacket is provided with openings 15A, 15B and an inner space to enable a user to put on the jacket 15. A rear cover sheet 2 is provided with at least one fixing member 21A and one corresponding fixing member 21B (see FIGS. 19 and 20). A first joining edge 131 is provided on the front cover sheet 1, a second joining edge 231 is provided on the rear cover sheet 2, and the flexible enclosure 3 is fitted on the outer side of the jacket 15. The flexible enclosure 3 of the present embodiment is a body protective device such as either a protective clothing or an airbag clothing, which is used as an outer clothing or a covering for the wearer. The covering body comprises a third joining edge 331, and either the first joining edge 131 or the second joining edge 231 is used to join together with the third joining edge 331 and securely fix either the front cover sheet 1 or the rear cover sheet 2 to the covering body. A retaining space formed between the front cover sheet 1 and the rear cover sheet 2 is used to retain the folded up covering body; moreover, the fixing members 21A and the corresponding fixing members 21B are further used to close up the front cover sheet 1 and the rear cover sheet 2 (see FIG. 19). When the body protective device is an airbag clothing, the airbag clothing comprises an inner air bag 3D and an outer air bag 3F, wherein the structures of the inner and outer air bags 3D, 3F can be either a single air bag or a plurality of independent air bags. Using a plurality of independent air bags as an example, each of the independent air bags is provided with an independent air chamber and a free end. When in a deflated state, a partial overlapping configuration is assumed between each of the airbags. When in an inflated state, the air bags are set upright and connected together.

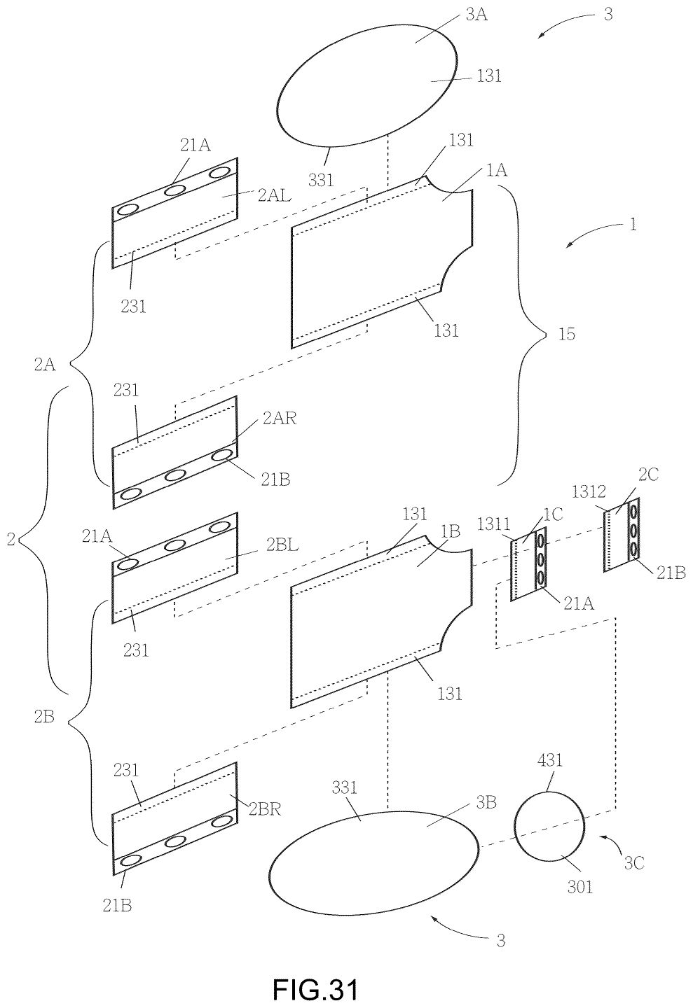

Concrete examples of the present embodiment primarily consist of three configurations. From the cross-sectional views, wherein the rear cover sheet 2 further comprises a first covering piece 2A, which is fitted to the periphery of the jacket 15. The first covering piece 2A is further fitted with a front left covering piece 2AL and a front right covering piece 2AR, wherein the front left covering piece 2AL and the front right covering piece 2AR respectively use the second joining edge 231 and the first joining edge 131 to connect to the front inner piece 1A. The front left, right covering pieces 2AL, 2AR are respectively provided with the at least one fixing member 21A and the corresponding fixing member 21B. The covering body further comprises a front covering body 3A, which comprises a third joining edge 331, wherein either the first joining edge 131 or the second joining edge 231 is used to join together with the third joining edge 331 and securely fix the front inner piece 1A and the front left, right covering pieces 2AL, 2AR to the front covering body 3A (see FIG. 31). The retaining space formed between the front inner piece 1A and the left, right covering pieces 2AL, 2AR is able to retain the folded up front covering body 3A; moreover, the fixing members 21A and the corresponding fixing members 21B are further used to close up the left, right covering pieces 2AL, 2AR. The rear cover sheet 2 further comprises a second covering piece 2B, which is fitted with a rear left covering piece 2BL and a rear right covering piece 2BR, wherein the rear left, right covering pieces 2BL, 2BR are respectively provided with the at least one fixing member 21A and the corresponding fixing member 21B. The covering body further comprises a rear covering body 3B, and the retaining space formed between the rear inner piece 1B and the left, right covering pieces 2BL, 2BR is used to retain the folded up rear covering body 3B, as well as further close up the rear left, right covering pieces 2BL, 2BR using the fixing members 21A and the corresponding fixing members 21B.

The second configuration of the present embodiment is shown in FIG. 29 (a cross-sectional view), wherein the first covering piece 2A corresponds to the inner piece 1A, and the first covering piece 2A is fitted to the periphery of the front side of the jacket 15; moreover, the starting point of the first covering piece 2A is P1. The fixing members 21A are fitted to the first covering piece 2A, and the corresponding fixing members 21B are fitted to the edge of the front inner piece 1A, wherein the edge of the front inner piece 1A is a terminal point P2. The retaining space formed between the front inner piece 1A and the first covering piece 2A is able to retain the folded up front covering body 3A; moreover, the fixing members 21A and the corresponding fixing members 21B are used to close up the first covering piece 2A. After closing up the first covering piece 2A, starting from point P1, the first covering piece 2A is made to cover the front covering body 3A within the range to the terminal point P2 (the first covering piece 2A can also set P2 as the starting point and P1 as the terminal point). The same structure as described above can also be applied in the second covering piece 2B contained in the rear cover sheet 2, wherein the second covering piece 2B is fitted to the periphery of the rear side of the jacket 15, and the starting point of the second covering piece 2B is P2. The fixing members 21A are fitted to the second covering piece 2B, and the corresponding fixing members 21B are fitted to the edge of the front inner piece 1B. The edge of the front inner piece 1B is the terminal point P1. The covering body further comprises the rear covering body 3B, and the retaining space formed between the rear inner piece 1B and the second covering piece 2B is used to retain the folded up rear covering body 3B, and also closes up the second right covering piece 2B using the fixing members 21A and the corresponding fixing members 21B. After closing up, starting from point P2, the second covering piece 2B is made to cover the rear covering body 3B within the range to the terminal point P1 (the second covering piece 2B can also set P1 as the starting point and P2 as the terminal point).

The third configuration of the present embodiment is shown in FIG. 30 (a cross-sectional view), wherein the configuration is realized with only the single covering piece 2AB fitted to the periphery of the front side of the jacket 15. The single covering piece 2AB corresponds to the single inner piece 1AB, and the starting point of the single covering piece 2AB is P1. Moreover, the fixing members 21A are fitted to the single covering piece 2AB, and the corresponding fixing members 21B are fitted to the edge of the single inner piece 1AB. The retaining space formed between the single inner piece 1AB and the single covering piece 2AB is able to retain the folded up single covering body 3AB, and also closes up the single covering piece 2AB using the fixing members 21A and the corresponding fixing members 21B. After closing up, the range covered by the single covering piece 2AB includes coiling round once starting from the starting point P1 and returning to the original starting point P1.

Referring to FIGS. 21 to 24, which show the covering body of the present embodiment further comprising an upper covering body 3C, which is fitted to the upper side of the jacket 15, and can be used to cover the head portion of a wearer. In addition, the upper covering body 3C is fitted with an upper inner piece 1C and an upper covering piece 2C, wherein the upper inner piece 1C is provided with a first upper joining edge 1311, and the upper covering piece 2C is provided with a second upper joining edge 1312. The first, second upper joining edges 1311, 1312 are joined together, and the retaining space formed between the upper inner piece 1C and the upper covering piece 2C is used to retain the folded up upper covering body 3C. The upper inner piece 1C and the upper covering piece 2C are respectively provided with the fixing members 21A and the corresponding fixing members 21B; moreover, the upper inner piece 1C and the upper covering piece 2C are also closed up using the fixing members 21A and the corresponding fixing members 21B. The upper covering body 3C further comprises a plurality of pleats 310, 320, 330, and in a folded state, the plurality of pleats 310, 320, 330 are used to collect together and fold up the upper covering body 3C.

In addition, referring to FIGS. 21, 22, and 25, the front inner piece 1A, the rear inner piece 1B, and the upper inner piece 1C of the present embodiment positioned on one side of the inner space of the jacket 15 are provided with a plurality of supporting protrusions 3D. Connective channels 3P are provided between the plurality of supporting protrusions 3D, and the connective channels 3P are used to channel air to the interior of the supporting protrusions 3D, thereby causing the supporting protrusions 3D to form bulging structures provided with adequate supporting force. The inner space of the jacket 15 contacts one side of the wearer's body and is used to form a protective effect; moreover, because the plurality of supporting protrusions 3D assume a transverse, longitudinal, or diagonal arrangement, thus, long gaps 3G are also formed between the rows and columns of the supporting protrusions 3D. When the protective clothing or airbag clothing unfolds and inflates, the wearer's hands are free to carry out other operations using the long gaps 3G, for example: operating survival equipment or a mobile phone, eating and drinking, taking things out from their clothing pockets or carry bag, etc.

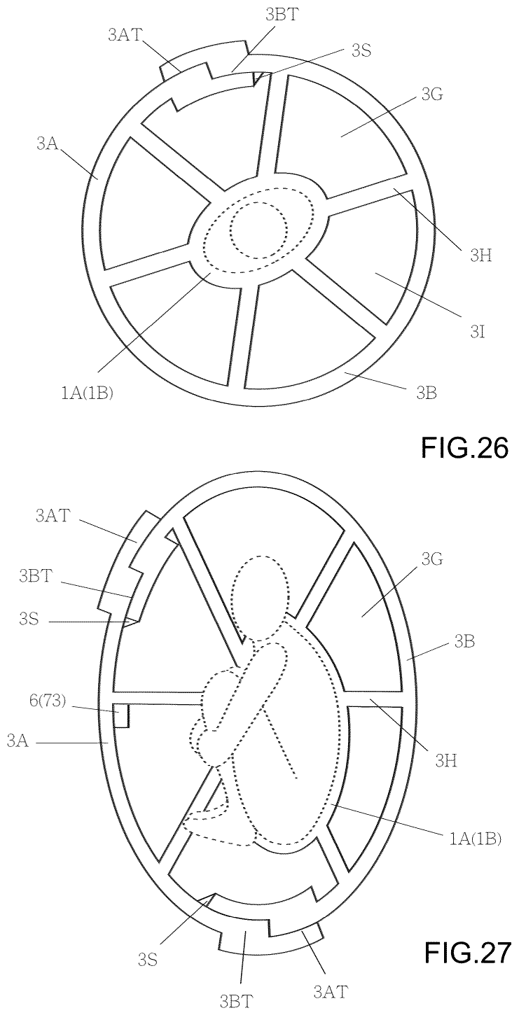

Referring to FIGS. 26, 27, and FIG. 31, which show an embodiment of the present invention applying the covering body in a body protective device, such as a hollow spherical body or a hollow airbag. The body protective device is provided with a plurality of supporting columns 3H, which are either inflatable air cylindrical body structures or foldable elastic cylindrical bodies. In addition, the plurality of supporting columns 3H are connected to either the front inner piece 1A or the rear inner piece 1B, with the plurality of supporting columns 3H used to support and fix the configurational shape of the exterior of the hollow spherical body or the hollow airbag by causing the exterior to assume an airbag cover body with a spherical body shape, circular shape, or an elliptical shape. When the supporting columns 3H are configured as air column structures, connective inflating channels are provided between the air column structures and the hollow spherical body or the surface of the hollow spherical body. The surface of the hollow spherical body or the hollow airbag can be configured as a single sheet flat surface or a plurality of airbag surfaces. A structure with a plurality of independent airbags structure can be adopted when configured as a plurality of airbags, such as the outer air bags 3F shown in FIGS. 21 and 22, with each of the independent airbags provided with an independent air chamber and a free end. When in an deflated state, the airbags assume a partial overlapping configuration, and when in an inflated state, the air bags are set upright and connected together. The hollow spherical body or the hollow airbags either comprise at least the front cover sheet 1 or the rear cover sheet 2, and further comprises at least one joining opening, which is formed from the joining of two joining ends 3AT, 3BT. In addition, each of the joining openings is provided with a sealing member 3S, which can be either a zipper, hook and loop fastener, magnetic fastener, or zipper adhesive tape.

Referring to FIG. 31, wherein a body protective device comprises either an air supply 5, a manual inflating device 6, or an automatic inflating device 7, wherein the air supply 5 can be an inflation tube, a pump, or a pressure bottle. The manual inflating device 6 is fitted with a valve 8 for the purpose of respectively channeling air from the air supply 5 to inside the fitted airbags at the front, rear, and upper covering bodies 3A, 3B, and 3C, which respectively use a first, second, and third manual inflating device 61A, 61B, and 61C to control opening of a first, second, and third valve 81A, 81B, and 81C, thereby achieving the objective of inflating the airbags. in an emergency situation, the jacket wearer can carry out a manual inflating operation respectively on the front, rear, or upper covering bodies 3A, 3B, 3C according to circumstances (see FIGS. 21 or 27). The automatic inflating device 7 is fitted with a synchronous start switch 71, a sensor 72, and a manual changeover switch 73. In an emergency situation, the sensor 72 transmits a signal to the synchronous start switch 71 to open a fourth valve 81D and channel in air from the air supply 5 to enable achieving the objective of inflating the airbags. Under certain conditions, when the sensor 72 malfunctions or is inappropriate to auto-start, the manual changeover switch 73 can be used to control the fourth valve 81D (see FIGS. 21 or 27). In addition, the body protective device can further comprise a global satellite positioning device 9, which is connected to the synchronous start switch 71 and the sensor 72 (see FIG. 22). In an emergency situation, the sensor 72 can automatically transmit a satellite positioning signal to facilitate rescuing the accident victim. The front manual inflating device 6 comprises a device such as a conventional inflation tube, pump, or a one-way valve, and further comprises a device to open the valve, such as a pull cord or water soluble material using various types of physical or chemical principles.

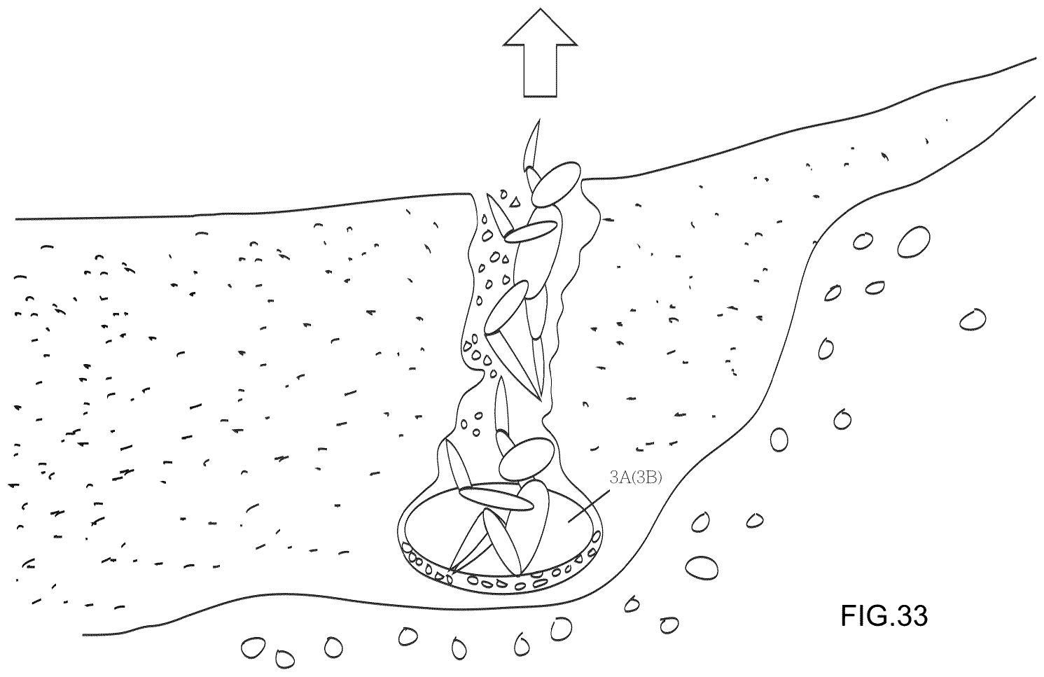

When the body protective device of the present invention is applied in mountain-climbing activities as an example, and a climber accidentally falls into a valley, the sensor 72 immediately transmits a signal to the synchronous start switch 71, causing the fourth valve 81D to open and channel air from the air supply 5 to achieve the effect of inflating the airbags of the covering body, forming an elliptical shaped or circular shaped body protective device that covers the wearer's body, thereby protecting the wearer from otherwise fatal injuries from falling into a valley. In particular, should an avalanche occur when climbing a high snow-capped mountain (see FIG. 33), and the wearer is buried under an accumulation of snow from the avalanche, because of the gaps 3G fitted inside the covering body (see FIG. 22 or 27), the wearer is able to manipulate or separate themself from the body protective device and use the space occupied by the body protective device after being buried by the accumulation of snow to slowly, upwardly dig themself out from the accumulation of snow, causing the accumulation of snow to fall into the occupied space as they dig upward, finally seeking help on the surface away from the snow dugout. Apart from having use in activities such as skiing, mountain-climbing, etc., the body protective device can also be used when riding a motorcycle, in water activities such as boating, aerial activities such as paragliding and hand gliding, etc., or after pairing with essential life support equipment, can also be further applied in safety equipment for passengers travelling by airplane. According to the criteria required for each of the activities described above (such as: temperature, speed, altitude, pressure, impact force, etc.), the sensor 72 can be set to transmit the appropriate signal to the synchronous start switch 71 and when to transmit the signal.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A body-worn structure, comprising a flexible enclosure, an exit port and a lower opening, wherein the flexible enclosure further includes a front breadth and a rear breadth; the exit port is disposed above a space between the front breadth and the rear breadth, whereas the lower opening is disposed below a space between the front breadth and the rear breadth; an expansion/retaining device is disposed on an inner side of the front breadth, and further includes a front cover sheet, a rear cover sheet and a connecting portion, with that the front cover sheet is connected with the rear cover sheet by the connecting portion; the front cover sheet is provided with a first joining edge, the rear cover sheet is provided with a second joining edge, an inner side of the front breadth is provided with a third joining edge, and the front cover sheet or the rear cover sheet is connected with the third joining edge disposed on the inner side of the front breadth by the first joining edge or the second joining edge; a shoulder strap is disposed on the front cover sheet or the rear cover sheet and is connected with the front cover sheet or the rear cover sheet; a retaining space is formed between the front cover sheet and the rear cover sheet; and a cover piece is disposed on the periphery of the front cover sheet corresponding to a cover assembly disposed on the periphery of the rear cover sheet, so as to contain the folded front breadth and rear breadth folded into the retaining space and close the retaining space.

1. A body-worn structure, comprising:
a front cover sheet, which is a jacket formed from a front inner piece and a rear inner piece, wherein the jacket is provided with openings and an inner space to enable a user to put on the jacket;
a rear cover sheet provided with at least one fixing member and one corresponding fixing member;
a first joining edge provided on the front cover sheet;
a second joining edge provided on the rear cover sheet;
a flexible enclosure is fitted on an outer side of the jacket, the flexible enclosure is a covering body, which is a body protective device, such that either a protective clothing, an airbag clothing, a hollow spherical body, or a hollow airbag, the body protective device is used as an outer garment or as a covering for a wearer thereof; the covering body comprises a third joining edge; either the first joining edge or the second joining edge is used to join to the third joining edge to securely fix either the front cover sheet or the rear cover sheet to the covering body;
a retaining space formed between the front cover sheet and the rear cover sheet for retaining the folded up covering body, and further closing up the front cover sheet and the rear cover sheet using the fixing members and the corresponding fixing members; wherein, the body protective device comprises at least one air supply, and either a manual inflating device or an automatic inflating device; the automatic inflating device comprises a synchronous start switch and a sensor.

2. The body-worn structure according to claim 1, wherein the exit port includes at least a side extension port or a front opening.

3. The body-worn structure according to claim 1, wherein the periphery of the exit port is provided with a shrinking piece to facilitate restoring the exit port to the size of an ordinary neckline by the extension function of the shrinking piece after a user's head is sheathed out of the exit port when the user wears on the body-worn structure, with the shrinking piece including an elastic ribbon, a contraction band or a collecting element associated with a rope.

4. The body-worn structure according to claim 1, wherein the side extension port is extended toward shoulder portions and sleeve portions from a left and right side of the exit port, the exit port on a left and right side of an edge of the front breadth is provided with an upper open-close piece, and the exit port on a left and right side of an edge of the rear breadth is provided with an upper open-close assembly.

5. The body-worn structure according to claim 1, wherein the exit port is provided with a front opening at the front breadth, and edges on two sides of the front opening are provided respectively with a front open-close piece and a front open-close assembly, so as to open or close the front opening.

6. The body-worn structure according to claim 1, wherein a left and right opening is disposed between the front breadth and the rear breadth, the left and right openings are disposed respectively on a left and right side between the front breadth and the rear breadth and are extended from an armpit location below shoulder portions toward the lower opening, edges of the front breadth and the rear breadth at the left and right openings are provided with a left open-close piece, a left open-close assembly, a right open-close piece and a right open-close assembly, whereas the left opening and the right opening are extended to the lower opening and are connected together between the front breadth and the rear breadth to form a U-shaped opening that acts as a wear-on port.

7. The body-worn structure according to claim 1, wherein the rear breadth is provided with a rear opening and a back cover portion, with that the rear opening is extended toward the lower opening from a split location of the rear breadth, including a left piece and a right piece which are split with respect to each other; an edge of the left piece is provided with an open-close piece, and an edge of the right piece is provided with an open-close assembly; and the rear opening of a raincoat or coat is connected to the lower opening of the raincoat or coat to form an inverted-T opening that acts as a wear-on port.

8. The body-worn structure according to claim 1, wherein the flexible enclosure is further connected with a jumpsuit, the jumpsuit is connected to the front breadth or the rear breadth, a wear-on port of the jumpsuit is formed on a location where the jumpsuit is not connected to the front breadth or the rear breadth, the wear-on port is on the same location as a U-shaped opening formed by connecting the left and right openings to the lower opening, and the left and right openings are extended to an armpit location below sleeve portions respectively and toward the lower opening.

9. The body-worn structure according to claim 1, wherein the flexible enclosure is in shape of one piece of sheet material, and is bent and folded at a center to form the front breadth and the rear breadth, with that the left, right openings and the lower opening are connected between the front breadth and the rear breadth, an inner side of the left and right openings is provided respectively with a fixing portion, and two ends of the fixing portion are provided respectively with a first fixing member and a first fixing assembly, allowing a user's wrist to be fixed on the inner sides of the left, right openings.

10. The body-worn structure according to claim 1, wherein the front cover sheet or the rear cover sheet, vertically disposed below a connecting portion as an open end, is provided with a positioning portion opposite to the inner side of the front breadth, with that the positioning portion positions the front cover sheet or the rear cover sheet, the front cover sheet or the rear cover sheet is provided with a holding portion, and the positioning portion is a pocket which is provided with an insertion port with an upward opening, facilitating the front cover sheet or the rear cover sheet that is vertically disposed below the connecting portion, along with the holding portion, to be inserted from top to bottom.

11. The body-worn structure according to claim 1, wherein the expansion/retaining device is flexibly disposed on the inner side of the front breadth by flexible fixing members including zippers or magnetic components.

12. The body-worn structure according to claim 2, wherein the rear cover sheet further comprises first, second covering pieces or a single covering piece; the second joining edge and the first joining edge are used to connect to the front and rear inner pieces or a single inner piece; the first and second covering pieces or the single covering piece are provided with the at least one fixing member, and the front, rear inner pieces or the single inner piece are provided with at least one corresponding fixing member, the front, rear inner pieces or the single inner piece and the retaining space formed between the first and second covering pieces or the single covering piece to retain the folded up front, rear covering bodies or the single covering body;
moreover, the fixing members and the corresponding fixing members are used to close up the first and second covering pieces or the single covering piece.

13. The body-worn structure according to claim 2, wherein the first covering piece is fitted to a periphery of the jacket; moreover, the first covering piece is fitted with a front left covering piece and a front right covering piece, the front left covering piece and the front right covering piece respectively use the second joining edge and the first joining edge to connect to the front inner piece; the front rear, right covering pieces are respectively fitted with the at least one fixing member and at least one corresponding fixing member; the covering body further comprises a front covering body, the front covering body comprises a third joining edge; either the first joining edge or the second joining edge is used to join to the third joining edge, the front inner piece and the front left, right covering pieces are securely fixed to the front covering body; the retaining space formed between the front inner piece and the left, right covering pieces for retaining the folded up front covering body, and further closing up the left, right covering pieces using the fixing members and the corresponding fixing members.
